(19) United States
(12) Patent Application Publication
(10) Pub. No.: US 2015/0340736 A1
(43) Pub. Date: Nov. 26, 2015

(54) Electrolyte Including Additives for Lithium Secondary Battery and Lithium Secondary Battery Comprising Same

(71) Applicant: SK Innovation Co., Ltd., Seoul (KR)

(72) Inventors: Jin Sung Kim, Daejeon (KR); Seung Yon Oh, Daejeon (KR)

(21) Appl. No.: 14/409,422

(22) PCT Filed: Jun. 19, 2013
(86) PCT No.: PCT/KR2013/005426

§ 371 Date: Dec. 18, 2014

(30) Foreign Application Priority Data
Jun. 19, 2012 (KR) 10-2012-0065570

(51) Int. Cl. H01M 10/0567; H01M 10/0569

(52) U.S. Cl. CPC H01M 10/0567; H01M 10/0569; H01M 2300/0028

(57) ABSTRACT

Provided is a non-aqueous electrolyte for a lithium secondary battery, which is prepared by adding predetermined additives to a non-aqueous electrolyte. The non-aqueous electrolyte includes: (a) lithium difluorophosphate, (b) an (oxalato)borate compound including one or more selected from lithium bis(oxalato)borate and lithium difluoro(oxalato)borate; and (c) fluoroethylene carbonate or a sultone based compound. The present invention provides a non-aqueous lithium secondary battery capable of having excellent low-temperature discharge efficiency and high-temperature storage efficiency while significantly decreasing a thickness increase rate of the battery at the time of being exposed to a high temperature for a long period of time.

### TECHNICAL FIELD

The present invention relates to a non-aqueous electrolyte for a lithium secondary battery, which is prepared by adding predetermined additives to a non-aqueous electrolyte, and a lithium secondary battery comprising the same.

### BACKGROUND ART

A battery, which is an apparatus converting chemical energy generated at the time of an electrochemical redox reaction of chemicals contained therein into electric energy, may be divided into a primary battery that should be discarded in the case in which energy in the battery is completely consumed, and a secondary battery capable of being charged several times. Among them, the secondary battery may be charged and discharged several times using a reversible mutual conversion between chemical energy and electric energy.

According to the related art, a lithium secondary battery is composed of a lithium metal mixed oxide as a cathode active material, a metal lithium, or the like, as an anode active material, and an electrolyte in which a suitable amount of a lithium salt is dissolved in an organic solvent.

Recently, a demand for improving performance of a battery, particularly, excellent charge and discharge performance has increased, and in order to satisfy this demand, a technology of adding a specific compound in a non-aqueous electrolyte has been actively developed.

In association with an operation and use of the battery, generally the following features are required in the non-aqueous electrolyte. First, at the time of intercalation and deintercalation of lithium ions in a cathode and an anode, the non-aqueous electrolyte should be capable of sufficiently transferring ions between two electrodes. Second, the non-aqueous electrolyte is electrochemically stable at a potential difference between two electrodes, such that a risk of generation of side reactions such as decomposition of an ingredient of the electrolyte, or the like, should be low.

However, a potential difference between a carbon electrode and a lithium metal compound electrode, which are generally used as the cathode and the anode of the battery, is about 0 to 4.3 V, such that a general electrolyte solvent such as a carbonate based organic solvent may be decomposed on a surface of the electrode during charge and discharge, thereby generating side reactions in the battery. In addition, an organic solvent such as propylene carbonate (PC), dimethyl carbonate (DMC), diethyl carbonate (DEC), or the like, may be co-intercalated between graphite layers in a carbon based anode, thereby destroying a structure of the anode.

Meanwhile, it was known that these problems according to the related art may be solved by a solid electrolyte interface (hereinafter, referred to as ‘SEI’) membrane formed on a surface of the anode by electric reduction of a carbonate based organic solvent at the time of initial charge of the battery.

However, in general, the SEI membrane formed by the carbonate based organic solvent according to the related art is not electrochemically or thermally stable, such that the SEI membrane may be easily destroyed by electrochemical energy and thermal energy increased as the battery is charged and discharged. Therefore, while the battery is charged and discharged, the SEI membrane may be continuously re-produced, such that capacity of the battery may be decreased, and lifespan performance of the battery may be deteriorated. Further, side reactions such as destruction of the electrolyte may be generated on the surface of the anode exposed by decomposition of the SEI membrane, and due to gas generated at this time, which may cause problems that the battery is swelled or internal pressure is increased.

A non-aqueous electrolyte containing lithium difluorophosphate by reacting a halide except for fluoride with LiPF6 and water in a non-aqueous solvent to form lithium difluorophosphate capable of being an additive effective for improving performance of a non-aqueous electrolyte battery has been disclosed in Korean Patent Laid-Open Publication No. 10-2009-0118117(A) (Patent Document 1). Since this non-aqueous electrolyte contains lithium difluorophosphate, the SEI membrane may be formed by lithium difluorophosphate, such that decomposition of the electrolyte may be suppressed, and a thickness increase rate of the battery may be minimized. However, it is necessary for a non-aqueous electrolyte additive to be capable of having excellent charge and discharge cycles while minimizing the thickness increase rate of the battery as described above, that is, excellently maintaining low-temperature performance, high-temperature storage performance, initial capacity, and charge and discharge lifespan characteristics of a lithium secondary battery has been increased.

### DISCLOSURE

### Technical Problem

An object of the present invention is to provide a non-aqueous electrolyte capable of improving low-temperature performance, high-temperature storage performance, initial capacity and charge and discharge lifespan characteristics of a lithium secondary battery, more specifically, capable of having excellent low-temperature discharge efficiency and high-temperature storage efficiency simultaneously with minimizing a thickness increase rate of the battery when the lithium secondary battery is exposed to a high temperature for a long period of time.

### Technical Solution

In one general aspect, a non-aqueous electrolyte contains:

(a) lithium difluorophosphate;

(b) an (oxalato)borate compound which includes one or more selected from lithium bis(oxalato)borate and lithium difluoro(oxalato)borate; and

(c) fluoroethylene carbonate or a sultone based compound.

The non-aqueous electrolyte may contain one or two or more non-aqueous organic solvent selected from the group consisting of cyclic carbonates and chain carbonates, and a lithium salt compound.

In more detail, the non-aqueous electrolyte may contain 0.1 to 5% of the lithium difluorophosphate, 0.1 to 5% of the (oxalato)borate compound, and 0.1 to 5% of the fluoroethylene carbonate or sultone based compound.

The sultone based compound may be any one or a mixture of two or more selected from the group consisting of ethane sultone, propane sultone, butane sultone, ethene sultone, propene sultone, and butene sultone.

The non-aqueous electrolyte may contain one or two or more non-aqueous organic solvent selected from the group consisting of cyclic carbonates and chain carbonates, and a lithium salt compound.

The cyclic carbonate may be selected from the group consisting of ethylene carbonate, propylene carbonate, butylene carbonate, vinylene carbonate, vinylethylene carbonate, and a mixture thereof, and the chain carbonate may be selected from the group consisting of dimethyl carbonate, diethyl carbonate, dipropyl carbonate, ethyl methyl carbonate, methyl propyl carbonate, methyl isopropyl carbonate, ethyl propyl carbonate, and a mixture thereof.

The lithium salt compound may be one or two or more selected from LiPF6, LiBF4, LiClO4, LiSbF6, LiAsF6, LiN(SO2C2F5)2, Li(CF3SO2)2N, LiN(SO3C2F5)2, LiCF3SO3, LiC4F9SO3, LiC6H5SO3, LiSCN, LiClO4, LiAlO2, LiAlC14, LiN(CxF2x+1SO2)(CyF2y+1SO2) (here, x and y are natural numbers), LiCl, and LiI.

The non-aqueous electrolyte may further contain an amide based coupling agent.

The amide based coupling agent may be one or two or more selected from 1,3-dicyclohexylcarboimide, 1-ethyl-3-(3-dimethylaminopropyl)carbodiimide, and di-n-hexylcarbodiimide.

In another general aspect, a lithium secondary battery contains the non-aqueous electrolyte as described above.

When the lithium secondary battery according to the present invention is exposed to 60° C. for 30 days, a thickness increase rate of the battery may be 0.1 to 5%.

### Advantageous Effects

A non-aqueous electrolyte according to the present invention contains lithium difluorophosphate, an (oxalato) borate compound, and fluoroethylene carbonate or a sultone based compound, thereby making it possible to further improve low-temperature performance, high-temperature storage performance, initial capacity, and charge and discharge lifespan characteristics of a lithium secondary battery. More specifically, the non-aqueous electrolyte according to the present invention may have excellent low-temperature discharge efficiency and high-temperature storage efficiency while minimizing a thickness increase rate of the battery when a lithium secondary battery is exposed to a high temperature for a long period of time.

### BEST MODE

Hereinafter, the present invention will be described in more detail.

The present invention provides a non-aqueous electrolyte containing (a) lithium difluorophosphate, (b) an (oxalato)borate compound which includes one or more selected from lithium bis(oxalato)borate and lithium difluoro(oxalato)borate; and (c) fluoroethylene carbonate or a sultone based compound.

Each of the configurations will be described in detail.

First, the lithium difluorophosphate (a) forms a solid electrolyte interface (SEI) membrane by a reaction with lithium on cathode and anode interfaces. The SEI membrane blocks side reactions such as decomposition of the electrolyte, or the like, thereby suppressing a thickness of the battery from being increased by gas generation.

A content of lithium difluorophosphate is preferably 0.1 to 5 wt %, more preferably, 0.1 to 3 wt %. In the case in which the content is less than 0.1 wt %, cycle characteristics and durability such as high-temperature preservation performance, or the like, of a non-aqueous electrolyte battery by lithium difluorophosphate may be deteriorated, such that an effect of suppressing gas generation may become insufficient, and in the case in which the content is more than 5 wt %, ion conductivity of the electrolyte may be deteriorated, such that internal resistance may be increased.

The (oxalato)borate compound (b) which includes one or more selected from lithium bis(oxalato)borate and lithium difluoro(oxalato)borate prevents degradation at a high voltage.

A content of this (oxalato)borate compound is not particularly limited, but may be 0.1 to 10 wt %, more preferably 0.1 to 5 wt %.

Fluoroethylene carbonate or the sultone based compound (c) is reduced and decomposed on a surface of an anode active material at a potential of less than 1V based on lithium when lithium ions are intercalated on the surface of the anode active material, thereby forming the SEI membrane.

When the fluoroethylene carbonate or sultone based compound (c) is contained in the non-aqueous electrolyte together with the above-mentioned lithium difluorophosphate and (oxalato)borate, a good quality solid electrolyte interface (SEI) membrane is formed. Since the good quality interface membrane formed as described above may allow the lithium secondary battery to maintain high low-temperature discharge efficiency and high-temperature storage efficiency even at the time of being exposed to a high temperature for a long period of time, and simultaneously serve to control side reactions such as decomposition of the electrolyte on the surface of the anode material, or the like, and suppress generation of gas, thereby decreasing a thickness increase rate of the battery. The present inventors studied a configuration capable of solving a charge and discharge cycle performance deterioration problem, a disadvantage of additives for controlling the thickness increase rate of the battery, which was a problem according to the related art, thereby completing the present invention.

That is, according to a preferable aspect of the present invention, the non-aqueous electrolyte contains lithium difluorophosphate, (oxalato)borate, and fluoroethylene carbonate. Further, according to another preferable aspect of the present invention, the non-aqueous electrolyte contains lithium difluorophosphate, (oxalato)borate, and the sultone based compound.

The non-aqueous electrolyte according to the present invention forms the solid electrolyte interface (SEI) membrane, that is, the good quality interface membrane, on the surface of the anode at the time of initial charge, and this SEI membrane serves to suppress the electrolyte from being decomposed by a contact of the electrolyte with a cathode active material and anode active material to suppress self-discharge, and to improve preservation characteristics after charge.

When the decomposition of the electrolyte is suppressed as described above, a generation amount of gas in the battery is decreased, thereby suppressing a thickness of the battery from being increased by generation of gas. In addition, when the preservation characteristics after charge are improved, a decrease in capacity of the battery after charging and discharging the battery several times, which is a disadvantage of lithium difluorophosphate, may be prevented, and accordingly, the battery may have excellent cycle lifespan characteristics even at a high voltage.

The kind of sultone base compound is not particularly limited, but may be one or a mixture of two or more selected from the group consisting of ethane sultone, propane sultone, butane sultone, ethene sultone, propene sultone, and butene sultone.

Fluoroethylene carbonate include fluorine having a strong electron withdrawing action, such that a solid electrolyte interface membrane having high permittivity and excellent lithium ion conductivity may be formed at the time of initial charge of the battery.

A content of fluoroethylene carbonate or the sultone based compound (c) is not particularly limited, but may be 0.1 to 5 wt %, more preferably 0.1 to 3 wt %.

A content of each ingredient of the non-aqueous electrolyte according to an exemplary embodiment of the present invention is not particularly limited, but it is preferable that the non-aqueous electrolyte contains 0.1 to 5 wt % of lithium difluorophosphate, 0.1 to 10 wt % of the (oxalato)borate compound, and 0.1 to 5 wt % of fluoroethylene carbonate or the sultone based compound. When lithium difluorophosphate, the (oxalato)borate compound, and fluoroethylene carbonate or the sultone based compound are contained at the above-mentioned weight ratios, cycle lifespan of the lithium secondary battery may be further maximized. In detail, when each ingredient is contained at the above-mentioned weight ratio, the decrease in capacity of the battery after charging and discharging the battery several times, which is the disadvantage of lithium difluorophosphate, may be minimized by combination with other ingredients, that is, the (oxalato)borate compound, and fluoroethylene carbonate or the sultone based compound, and accordingly, excellent cycle lifespan characteristics may be implemented even at a high voltage. This may be appreciated through evaluation results of high-temperature storage efficiency and low-temperature discharge efficiency according to Examples of the present invention.

Meanwhile, the non-aqueous electrolyte according to the present invention may contain one or two or more non-aqueous organic solvent selected from the group consisting of cyclic carbonates and chain carbonates, and a lithium salt compound.

The cyclic carbonate may be selected from the group consisting of ethylene carbonate (EC), propylene carbonate (PC), butylene carbonate (BC), vinylene carbonate (VC), vinylethylene carbonate (VEC), and a mixture thereof, and the chain carbonate may be selected from the group consisting of dimethyl carbonate (DMC), diethyl carbonate (DEC), dipropyl carbonate (DPC), ethylmethyl carbonate (EMC), methylpropyl carbonate (MPC), methylisopropyl carbonate, ethylpropyl carbonate (EPC), and a mixture thereof.

In detail, specific examples of the non-aqueous organic solvent, which is a combination of the cyclic carbonate and the chain carbonate, may include a combination of ethylene carbonate and dimethyl carbonate, a combination of ethylene carbonate and ethylmethyl carbonate, a combination of ethylene carbonate and diethyl carbonate, a combination of propylene carbonate and dimethyl carbonate, a combination of propylene carbonate and methylethyl carbonate, a combination of propylene carbonate and diethyl carbonate, a combination of ethylene carbonate, propylene carbonate, and dimethyl carbonate, a combination of ethylene carbonate, propylene carbonate, and methylethyl carbonate, a combination of ethylene carbonate, propylene carbonate, diethyl carbonate, a combination of ethylene carbonate, dimethyl carbonate, and methylethyl carbonate, a combination of ethylene carbonate, dimethyl carbonate, and diethyl carbonate, a combination of ethylene carbonate, propylene carbonate, dimethyl carbonate, and methylethyl carbonate, and a combination of ethylene carbonate, propylene carbonate, dimethyl carbonate, and diethyl carbonate, and the like.

A mixing weight ratio of the cyclic carbonate and at least one chain carbonate may be 0:100-100:0, preferably 5:95˜80:20, more preferably 10:90˜70:30, and most preferably 15:85˜55:45. An increase in viscosity of the non-aqueous electrolyte may be further suppressed by mixing the cyclic carbonate and the chain carbonate with each other at the above-mentioned ratio, such that a degree of dissociation of the electrolyte may be further increased. Therefore, conductivity of the electrolyte associated with charge and discharge characteristics of the lithium secondary battery may be further increased.

The lithium salt is a material that is dissolved in the non-aqueous organic solvent to act as a supply source of the lithium ion in the battery, enables a basic operation of the lithium secondary battery, and serves to promote movement of the lithium ion between the cathode and the anode. Representative examples of this lithium salts include one or two or more selected from LiPF₆, LiBF₄, LiClO₄, LiSbF₆, LiAsF₆, LiN (SO₂C₂F₅)₂. Li (CF₃SO₂)₂N, LiN (SO₃C₂F₅)₂, LiCF₃SO₃, LiC₄F₉SO₃, LiC₆H₅SO₃, LiSCN, LiClO₄, LiAlO₂, LiAlCl₄, LiN(CₓF₂ₓ₊₁SO₂)(C_{y}F_{2y+1}SO₂) (here, x and y are natural numbers), LiCl, and LiI as a supporting electrolytic salt.

It is preferable that a concentration of the lithium salt is in a range of 0.1 to 2.0 M. When the concentration of the lithium salt is in the above-mentioned range, since the electrolyte has suitable conductivity and viscosity, the electrolyte may have excellent performance, and the lithium ion may effectively move. The non-aqueous organic solvent serves as a medium in which the lithium ion may move.

In addition, the non-aqueous electrolyte according to an exemplary embodiment of the present invention may further contain an amide based coupling agent. It was confirmed that the amide based coupling agent may be contained in the non-aqueous electrolyte according to the present invention to increase an adhesion property of the good quality interface membrane and suppress a decomposition reaction. In addition, it was found that the amide based coupling agent may increase moisture resistance and heat resistance of the interface membrane to prevent the decomposition reaction at a high temperature. Therefore, in the case in which the non-aqueous electrolyte according to the present invention contains an imide based coupling agent, the lithium secondary battery of which low-temperature discharge efficiency, high-temperature storage efficiency, and the thickness increase rate of the battery are excellent may be manufactured.

When the amide based coupling agent as described above is added together with lithium difluorophosphate, the (oxalato)borate compound, and fluoroethylene carbonate or the sultone based compound, an effect thereof is maximized, such that the amide based coupling agent may contribute to suppressing generation of gas and expansion due to additives, thereby serving to solve a problem that a thickness of the battery is increased.

Examples of the amide based coupling agent may include 1,3-dicyclohexylcarboimide, 1-ethyl-3-(3-dimethylaminopropyl)carbodiimide, di-n-hexylcarbodiimide, and the like. A content thereof is not particularly limited, but may be 0.01 to 1 wt %, more preferably 0.01 to 0.5 wt %.

A lithium secondary battery containing the non-aqueous electrolyte according to the present invention is included in the scope of the present invention.

In the case of a secondary battery manufactured using the non-aqueous electrolyte according to the present invention, a thickness increase rate thereof is significantly low. When exposure of the secondary battery manufactured using the non-aqueous electrolyte according to the present invention to 60° C. is over 30 days, a thickness increase rate of the battery is 0.1 to 5%.

The lithium secondary battery according to the present invention includes a cathode and an anode. The cathode contains a cathode active material capable of intercalating and deintercalating lithium ions, wherein as this cathode active material, a complex metal oxide of at least one metal selected from cobalt, manganese, and nickel and lithium. A solid-solution rate between the metals may be various, and an element selected from the group consisting of Mg, Al, Co, K, Na, Ca, Si, Ti, Sn, V, Ge, Ga, B, As, Zr, Mn, Cr, Fe, Sr, V, and rare earth elements may be further contained in addition to the above-mentioned metals. The anode contains an anode active material capable of intercalating and deintercalating the lithium ion, wherein as this anode active material, a carbon material such as crystalloid carbon, amorphous carbon, carbon complex, a carbon fiber, or the like, a lithium metal, an alloy of lithium and another element, or the like, may be used. Examples of the amorphous carbon may include hard carbon, coke, mesocarbon microbead (MCMB) sintered at a temperature of 1500° C. or less, mesophase pitch-based carbon fiber (MPCF), and the like. Examples of the crystalloid carbon include graphite based materials, more specifically, natural graphite, graphitized coke, graphitized MCMB, graphitized MPCF, and the like. As the carbon material, a material of which a d002 interplanar distance is 3.35 to 3.38 Å, and a crystallite size Lc measured by X-ray diffraction is at least 20 nm or more may be preferable. Another element forming the alloy with lithium may be aluminum, zinc, bismuth, cadmium, antimony, silicon, lead, tin, gallium, or indium.

The cathode or anode may be prepared by dispersing an electrode active material, a binder, and a conductive material, and if necessary, a thickener, in a solvent to prepare an electrode slurry composition, and applying this electrode slurry composition onto an electrode current collector. As a cathode current collector, aluminum, an aluminum alloy, or the like, may be generally used, and as an anode current collector, copper, a copper alloy, or the like, may be generally used. The cathode current collector and the anode current collector have a foil or mesh shape.

The binder is a material playing a role in paste formation of the active material, adhesion between the active materials, adhesion with the current collector, and a buffering effect on expansion and contraction of the active material, and the like. Examples of the binder may include polyvinylidene fluoride (PVdF), polyhexafluoropropylene-polyvinylidene fluoride copolymer (PVdF/HFP), poly(vinylacetate), polyvinyl alcohol, polyethyleneoxide, polyvinylpyrrolidone, alkylated polyethyleneoxide, polyvinyl ether, poly(methylmethacrylate), poly(ethylacrylate), polytetrafluoroethylene, polyvinylchloride, polyacrylonitrile, polyvinylpyridine, styrene-butadiene rubber, acrylonitrile-butadiene rubber, and the like. A content of the binder is 0.1 to 30 wt %, preferably 1 to 10 wt % with respect to the electrode active material. In the case in which the content of the binder is excessively low, adhesive force between the electrode active material and the current collector may become insufficient, and in the case in which the content of the binder is excessively high, adhesive force may be improved, but a content of the electrode active material is decreased in accordance with the content of the binder, which is disadvantageous in allowing the battery to have high capacity.

As the conductive material, which is a material improving electron conductivity, at least one selected from the group consisting of a graphite based conductive material, a carbon black based conductive material, and a metal or metal compound based conductive material may be used. Examples of the graphite based conductive material may include artificial graphite, natural graphite, and the like, examples of the carbon black based conductive material may include acetylene black, ketjen black, denka black, thermal black, channel black, and the like, and examples of the metal based or metal compound based conductive material may include tin, tin oxide, tin phosphate (SnPO4), titanium oxide, potassium titanate, a perovskite material such as LaSrCoO3 and LaSrMnO3. However, the conductive material is not limited thereto.

A content of the conductive material is preferably 0.1 to 10 wt % with respect to the electrode active material. In the case in which the content of the conductive material is less than 0.1 wt %, electrochemical properties may be deteriorated, and in the case in which the content is more than 10 wt %, energy density per weight may be decreased.

Any thickener may be used without limitation as long as it may serve to adjust a viscosity of the active material slurry, but for example, carboxymethyl cellulose, hydroxymethyl cellulose, hydroxyethyl cellulose, hydroxypropyl cellulose, or the like, may be used.

As the solvent in which the electrode active material, the binder, the conductive material, and the like, are dispersed, a non-aqueous solvent or aqueous solvent may be used. Examples of the non-aqueous solvent may include N-methyl-2-pyrrolidone (NMP), dimethylformamide, dimethylacetamide, N,N-dimethylaminopropylamine, ethyleneoxide, tetrahydrofuran, or the like.

The lithium secondary battery may include a separator preventing a short-circuit between the cathode and the anode and providing a movement path of the lithium ion. As the separator as described above, a polyolefin based polymer membrane made of polypropylene, polyethylene, polyethylene/polypropylene, polyethylene/polypropylene/polyethylene, polypropylene/polyethylene/polypropylene, or the like, or a multilayer thereof, a micro-porous film, and woven fabric and non-woven fabric may be used. In addition, a film in which a resin having excellent stability is coated on a porous polyolefin film may be used.

Hereinafter, the present invention will be described in more detail through the Examples, but the present invention is not limited to the Examples.

In addition, each compound will be referred to as follows.

EC: ethylene carbonate

EMC: ethyl methyl carbonate

LiPO2F2: lithium difluorophosphate

VC: vinylene carbonate

FEC: fluoroethylene carbonate

PS: 1,3-propane sultine

LiBOB: lithium bis(oxalato)borate

LiFOB: lithium difluoro(oxalato)borate

DCC: 1,3-dicyclohexyl carboimide

### EXAMPLE 1

A solution obtained by dissolving 1 M(mol/L) lithium salt (LiPF6) in a non-aqueous organic solvent in which EC and EMC were mixed at a content ratio of 3:7 (EC:EMC) depending on contents shown in the following Table 1 was used as a basic electrolyte. A non-aqueous electrolyte was prepared by adding trimethylsilylfluoride so as to have a content of 1 wt % and adding lithium bis(oxalato)borate so as to have a content of 1 wt % to the basic electrolyte.

A 25 Ah-class battery for an electric vehicle (EV) using the non-aqueous electrolyte was manufactured as follows.

After mixing LiNiCoMnO2 and LiMn2O4 at a weight ratio of 1:1 as a cathode active material, the cathode active material, polyvinylidene fluoride (PVdF) as a binder, and carbon as a conductive material were mixed at a weight ratio of 92:4:4 and then dispersed in N-methyl-2-pyrrolidone, thereby preparing cathode slurry. This slurry was coated on aluminum foil having a thickness of 20 μm, dried, and rolled, thereby preparing an cathode. After artificial graphite as an anode active material, styrene-butadiene rubber as a binder, and carboxymethyl cellulose as a thickener were mixed at a weight ratio of 96:2:2 and dispersed in water, thereby preparing anode active material slurry. This slurry was coated on copper foil having a thickness of 15 μm, dried, and rolled, thereby preparing an anode.

A film separator made of a polyethylene (PE) material and having a thickness of 20 μm was stacked between the prepared electrodes, and a cell was configured using a pouch having a size of 8 mm×270 mm×185 mm (thickness×length×width), followed by injection of the non-aqueous electrolyte, thereby manufacturing a 25 Ah-class lithium secondary battery for an electric vehicle (EV).

Performance of the 25 Ah-class battery for an electric vehicle (EV) manufactured as described above was evaluated as follows. Evaluation items are as follows.

[Evaluation Item]

1. 1 C Discharge at −20° C. (Low-temperature discharge efficiency): After charging the battery at room temperature for 3 hours (12.5 A, 4.2 V, constant current and constant voltage (CC-CV)), the battery was exposed to −20° C. for 4 hours, and then the battery was discharged to 2.7 V (25 A, CC). Then, usable capacity (%) with respect to initial capacity was measured.

2. Capacity recovery rate after 30 days at 60° C. (high-temperature storage efficiency): After charging the battery at room temperature for 3 hours (12.5 A, 4.2 V, CC-CV), the battery was exposed to 60° C. for 30 days, and then, the battery was discharged to 2.7 V (25 A, CC). Thereafter, usable capacity (%) with respect to initial capacity was measured.

3. Thickness increase rate after 30 days at 60° C.: When a thickness of the battery after charging the battery at room temperature for 3 hours (12.5 A, 4.2 V, CC-CV) was defined as A, and a thickness of the battery exposed to 60° C. for 30 days at an atmospheric pressure exposed in the air using a closed thermostatic device was defined as B, a thickness increase rate was calculated by the following Equation 1.

(B−A)/A*100(%) [Equation 1]

TABLE 1

| | | | Capacity | Thickness |
|---|---|---|---|---|
| | | | recovery | increase |
| | | | rate after | rate after |
| | | Discharge | 30 days at | 30 days at |
| | Composition | At −20° C. | 60° C. | 60° C. |
| Comparative | EC/EMC = 3:7 + | 72% | 58% | 15% |
| Example 1 | 1M LiPF₆ | | | |
| Comparative | Basic electrolyte + | 66% | 73% | 13% |
| Example 2 | VC1% | | | |
| Comparative | Basic electrolyte + | 85% | 65% | 8% |
| Example 3 | LiPO2F2 1% | | | |
| Comparative | Basic electrolyte + | 75% | 83% | 10% |
| Example 4 | LiPO2F2 1% + VC1% | | | |
| Comparative | Basic electrolyte + | 83% | 75% | 9% |
| Example 5 | LiPO2F2 1% + FEC1% | | | |
| Comparative | Basic electrolyte + | 70% | 80% | 7% |
| Example 6 | LiPO2F2 1% + PS 1% | | | |
| Example 1 | Basic electrolyte + | 92% | 90% | 1% |
| | LiPO2F2 1% + | | | |
| | FEC 1% + LiBOB 0.5% | | | |
| Example 2 | Basic electrolyte + | 93% | 93% | 2% |
| | LiPO2F2 1% + | | | |
| | FEC 1% + LiBOB 1% | | | |
| Example 3 | Basic electrolyte + | 88% | 91% | 1% |
| | LiPO2F2 1% + | | | |
| | FEC 1% + LiFOB 0.5% | | | |
| Example 4 | Basic electrolyte + | 91% | 93% | 2% |
| | LiPO2F2 1% + | | | |
| | FEC 1% + LiFOB 1% | | | |
| Example 5 | Basic electrolyte + | 89% | 94% | 1% |
| | LiPO2F2 1% + | | | |
| | PS 1% + LiBOB 0.5% | | | |

### EXAMPLES 2 TO 7

A non-aqueous electrolyte was prepared with reference to a composition corresponding to each Example shown in Table 1, and a battery was manufactured and evaluated by the same method as in Example 1. The results were shown in Table 1.

### COMPARATIVE EXAMPLE 1

The battery was manufactured using the basic electrolyte of Example 1 as the non-aqueous electrolyte, and evaluated. The results were shown in Table 1.

### COMPARATIVE EXAMPLES 2 TO 6

Non-aqueous electrolytes were prepared with reference to the compositions corresponding to Comparative Examples 2 to 6 shown in Table 1, respectively, and a battery was manufactured and evaluated by the same method as in Example 1. The results were shown in Table 1.

As described above, it may be appreciated that the lithium secondary battery containing the non-aqueous electrolyte according to the present invention has low-temperature discharge efficiency of 86% or more and high-temperature storage efficiency of 90% or more. In addition, it was confirmed that when the battery was exposed to a high temperature for a long period of time, the thickness increase rate of the battery was significantly low (0.1 to 5%). Particularly, it may be appreciated that in the case of Example 7 to which 1,3-dicyclohexylcarboimide was applied, all of the low-temperature discharge efficiency, the high-temperature storage efficiency, and the thickness increase rate were excellent. Therefore, it may be expected that the non-aqueous electrolyte according to the present invention will significantly contribute to improving performance of the lithium secondary battery.

1. A non-aqueous electrolyte comprising:
(a) lithium difluorophosphate;
(b) an (oxalato)borate compound including one or two or more selected from lithium bis(oxalato)borate or lithium difluoro(oxalato)borate; and
(c) fluoroethylene carbonate or a sultone based compound.

2. The non-aqueous electrolyte of claim 1, wherein it contains 0.1 to 5 wt % of the lithium difluorophosphate, 0.1 to 10 wt % of the (oxalato)borate compound, and 0.1 to 5 wt % of the fluoroethylene carbonate or sultone based compound.

3. The non-aqueous electrolyte of claim 1, wherein the sultone based compound (c) is any one or a mixture of two or more selected from the group consisting of ethane sultone, propane sultone, butane sultone, ethene sultone, propene sultone, and butene sultone.

4. The non-aqueous electrolyte of claim 1, further comprising one or two or more non-aqueous organic solvents selected from the group consisting of cyclic carbonate and chain carbonate, and a lithium salt compound.

5. The non-aqueous electrolyte of claim 4, wherein the cyclic carbonate is selected from the group consisting of ethylene carbonate, propylene carbonate, butylene carbonate, vinylene carbonate, vinylethylene carbonate, and a mixture thereof, and the chain carbonate is selected from the group consisting of dimethyl carbonate, diethyl carbonate, dipropyl carbonate, ethylmethyl carbonate, methylpropyl carbonate, methylisopropyl carbonate, ethylpropyl carbonate, and a mixture thereof.

6. The non-aqueous electrolyte of claim 4, wherein the lithium salt compound is one or two or more selected from the group consisting of LiPF₆, LiBF₄, LiClO₄, LiSbF₆, LiAsF₆, LiN(SO₂C₂F₅)₂, Li(CF₃SO₂)₂N, LiN(SO₃C₂F₅)₂, LiCF₃SO₃, LiC₄F₉SO₃, LiC₆H₅SO₃, LiSCN, LiClO₄, LiAlO₂, LiAlCl₄, LiN(CₓF₂ₓ₊₁SO₂)(C_{y}F_{2y+1}SO₂) (here, x and y are natural numbers), LiCl, and LiI.

7. The non-aqueous electrolyte of claim 1, further comprising an imide based coupling agent.

8. The non-aqueous electrolyte of claim 7, wherein the imide based coupling agent is one or two or more selected from 1,3-dicyclohexylcarboimide, 1-ethyl-3-(3-dimethylaminopropyl)carbodiimide, and di-n-hexylcarbodiimide.

9. A lithium secondary battery comprising the non-aqueous electrolyte of claim 1.

10. A lithium secondary battery of claim 9, wherein when it is exposed to 60° C. for 30 days, a thickness increase rate is 0.1 to 5%.

11. A lithium secondary battery comprising the non-aqueous electrolyte of claim 2.
